(19) United States
(12) Patent Application Publication
(10) Pub. No.: US 2005/0195813 A1
(43) Pub. Date: Sep. 8, 2005

(54) Unified architecture for wired and wireless networks

(75) Inventors: Shekhar Ambe, San Jose, CA (US); Abhijit Choudhury, Cupertino, CA (US); Sudhanshu Jain, Fremont, CA (US); Mathew Kayalackakom, Cupertino, CA (US)

Correspondence Address: PILLSBURY WINTHROP SHAW PITTMAN LLP, ATTENTION: DOCKETING DEPARTMENT, 11682 EL CAMINO REAL, SUITE 200, SAN DIEGO, CA, 92130, US

(73) Assignee: SiNett Corporation, Sunnyvale, CA (US)

(21) Appl. No.: 11/064,899

(22) Filed: Feb. 23, 2005

Related U.S. Application Data
(60) Provisional application No. 60/547,111, filed on Feb. 23, 2004.

(51) Int. Cl. H04L 12/56

(52) U.S. Cl. 370/389

(57) ABSTRACT

A method and apparatus that makes it possible to have a single unified network where the devices at the edge are able to handle both wired and wireless traffic. Separate devices are not required to handle wired and wireless traffic. Instead the whole enterprise network comprises devices that are agnostic to the nature of the traffic and have all the features required by both wired and wireless traffic.

### CROSS REFERENCE TO RELATED APPLICATIONS

The present application claims priority to provisional application 60/547,111, filed on Feb. 23, 2004.

### BACKGROUND

1. Field of the Invention

Aspects of the present invention relate in general to the field of wireless communications. Embodiments include a unified architecture for wired and wireless networks, methods, and computer-readable media embodiments.

2. Background

Unlike wired Local Area Networks (LAN) 100, as shown in FIG. 1, wireless LAN poses very unique challenges because of the medium; this is particularly true for large enterprise deployments. Furthermore, it is being considered to run voice-over Internet Protocol (IP) in conjunction with data to further enhance the return of investment on this technology. This poses unique application specific challenge to maintain the quality of service for the voice-over IP latency requirements.

In the early days of Ethernet, personal computers 102 were simply connected to hub architecture. Turning to FIG. 2, this was also true of the wireless networks 200 where the client devices connect to a wireless access point 202, or wireless hub. The present WLAN deployment follows this traditional wired design approach that includes hard wiring dozens of access points (APs) to an existing wired network to cover the large areas where users demand wireless coverage. This is very effective for simple installations in a home or a small office, but scaling this architecture to large networks becomes problematic. This makes WLAN deployment expensive from an installation and management perspective.

The main challenges to enterprise wide WLAN deployment can be categorized as:
Security—Secure Network access, Data security, Rogue user detection and access prevention
Usability—Matching wired user performance and reliability
Mobility—Application persistence
User Management and Control—Managing user roaming, Network and application level access control
Network Management—Network growth and resource management Enhancing ROI

The solution is to satisfy wired and wired network requirements and approach the overall network design from a unified network architecture point of view. The integrated network is shown in FIG. 2.

There are many possible approaches to integrate a wireless network with a legacy wired network. Some of the popular strategies are:
Intelligent AP
WLAN Concentrator
WLAN Switch
WLAN Appliance

The first three approaches, as depicted in FIGS. 3, 4 and 5, involve the grouping of wireless LAN users into independent islands. The islands are then connected to Layer 2 or Layer 3 wired network infrastructure via what are referred to as intelligent APs, concentrators or WLAN Switches. These intermediate systems implement functionality for user access, traffic management (i.e., bandwidth management, load balancing etc.) and mobility management (roaming, access control) etc for wireless users.

The last approach “WLAN appliance,” shown in FIG. 6, involves the use of existing legacy L2/L3 switches to tunnel wireless traffic from an AP to a dedicated wireless appliance. The appliance is generally located in the data center within the enterprise network and provides all the necessary functionality to implement security, traffic management and mobility management for wireless users.

The choice regarding what approach to use depends on the network topology, number of users, traffic patterns, cost of implementation (which should includes cost of network topology changes in necessary) and cost and complexity of network management.

Intelligent Access Point

In this solution packets from the wireless LAN clients are processed by the Intelligent Access Point, shown in FIG. 3, and undergo media conversion before going out on the wire. The security is handled by the Intelligent Access Points that function as the 802.11 tunnel termination point for wireless clients. All wireless traffic between Access Point and wireless client is encrypted.

Intelligent AccessPoint Advantages:
When a network breach occurs the wireless network can be easily isolated.
Wired network is not exposed to tunneled traffic.

Disadvantages:
Access points are expensive and good coverage includes many such units.

Large installations of Intelligent Access Points are difficult to manage.
Mis-configured or un-configured Access Points are serious security holes.
Access Control capability is limited to using MAC address.
Roaming support within L2 network only
Application persistence within L2 network only
Creates islands of WLAN networks increasing management overhead.
Not a scalable solution and is mainly targeted for small enterprise networks
Intrusion Detection is typically not supported.

WLAN Concentrator

In a WLAN Concentrator solution, depicted in FIG. 4, packets from the wireless LAN clients are aggregated by the concentrator and forwarded for L2 L3 switching via the uplink. The Access Points in this case are dumb and limited in functionality and only perform media conversion from wireless to wired and vice-versa. The concentrator handles security and is the tunnel termination point for wireless clients. In addition the concentrator is also responsible for Access Point configuration, management and also performs limited Intrusion Detection.

Generally these embodiments have limited number of ports, and the packet processing, encryption and decryption is done in software running on a host processor.

WLAN Concentrator Advantages
When a network breach occurs the wireless network can be easily isolated.
Access points are inexpensive and more of such Access points can be installed to achieve good radio coverage.
Deployment of mis-configured or un-configured Access Point can be prevented as Access Point configuration is centralized

WLAN Concentrator Disadvantages
Limited crypto processing capability because it is typically implemented in software.
Support fewer Access Points per concentrator because of fewer ports.
Applicable only for integration with legacy wired network.
Limited Access Control capability as deep packet inspection is not possible.
Not a scalable solution and is mainly targeted for small enterprise networks
Creates islands of WLAN networks increasing management overhead
Does not include L2 and L3 switching features and hence includes the support of external L2-L3 switches in the network.

WLAN Switch

In a WLAN Switch solution, illustrated in FIG. 5, packets from the wireless LAN clients are aggregated by the WLAN switch and can also be locally switched. The Access Points in this case are dumb and limited in functionality and only perform media conversion from wireless to wired and vice-versa. The WLAN Switch handles security and is the tunnel termination point for wireless clients. In addition the WLAN Switch is also responsible for local Access Point configuration and management, Intrusion Detection and access control.

A WLAN switch is generally implemented using network processors, crypto processors and Layer 2 and Layer 3 switch chips and hence more expensive.

WLAN Switch Advantages:
When a network breach occurs the wireless network can be easily isolated.
Enables deployment of an all-wireless network architecture within an enterprise.
Ease of Access point administration
Access points are inexpensive and more of such Access Points can be installed to achieve good radio coverage.
Deployment of mis-configured or un-configured Access Point can be prevented as Access Point configuration is centralized

WLAN Switch Disadvantages:
A WLAN switch is generally implemented using network processors, crypto processors and Layer 2 and Layer 3 switch chips and hence more expensive.
Creates islands of WLAN networks increasing management overhead.
Typically does not include L2 and L3 switching features and hence includes the support of external L2 L3 switches in the network.

In a WLAN Appliance solution, shown in FIG. 6, 802.11 encrypted packets from the wireless LAN client is tunneled using proprietary encapsulation through the legacy L2 L3 network to the WLAN appliance. The WLAN appliance handles all the traffic from the wireless clients and performs forwarding. In addition the WLAN Appliance is also responsible for local Access Point configuration and management, Intrusion Detection, and access control. The Access Points in this case are dumb and normally does the media conversion from wireless to wired and vice-versa.

WLAN Applicance

A WLAN Appliance is generally implemented using network processors and crypto processors and hence more expensive.

WLAN Appliance Advantages:
Enables deployment of an all-wireless network architecture within an existing legacy enterprise network
Centralized device allows easy administration
Good roaming support within the L2 and L3 network.
Supports application persistence across the L2 and L3 network.

WLAN Appliance Disadvantages:
Network breach is harder to detect.
A network breach from the wireless network cannot be easily isolated.
Not a scalable solution and is more suitable for SOHO or small enterprise installations.
A WLAN appliance is generally implemented using network processors, crypto processors and Layer 2 and Layer 3 switch chips and hence more expensive.
Limited packet processing capability and unable to keep up may back to back traffic from APs within the entire network.
Single point of failure for entire wireless network.

### BRIEF DESCRIPTION OF THE DRAWINGS

FIG. 1 depicts a Local Area Network of the PRIOR ART.

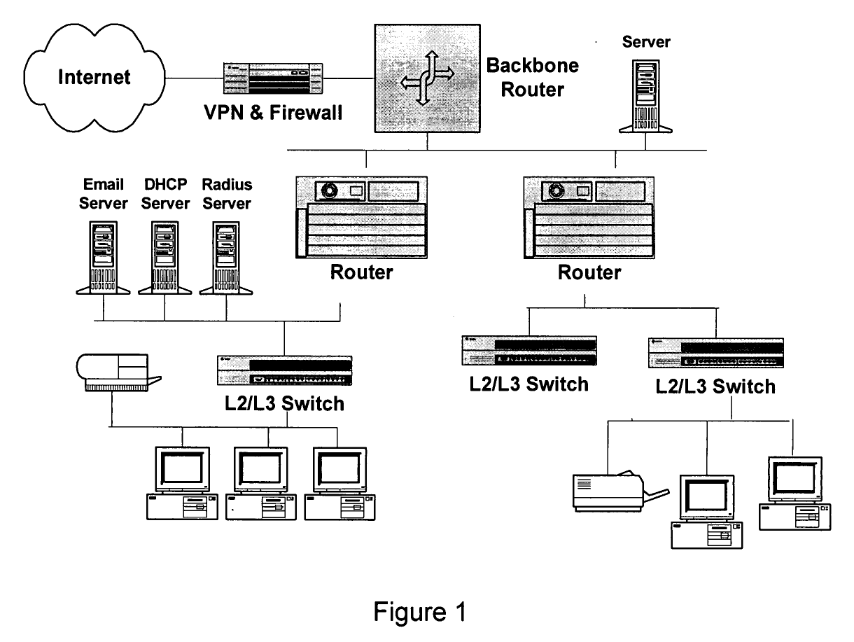

FIG. 2 depicts a Wired Wireless Local Area Network of the PRIOR ART.

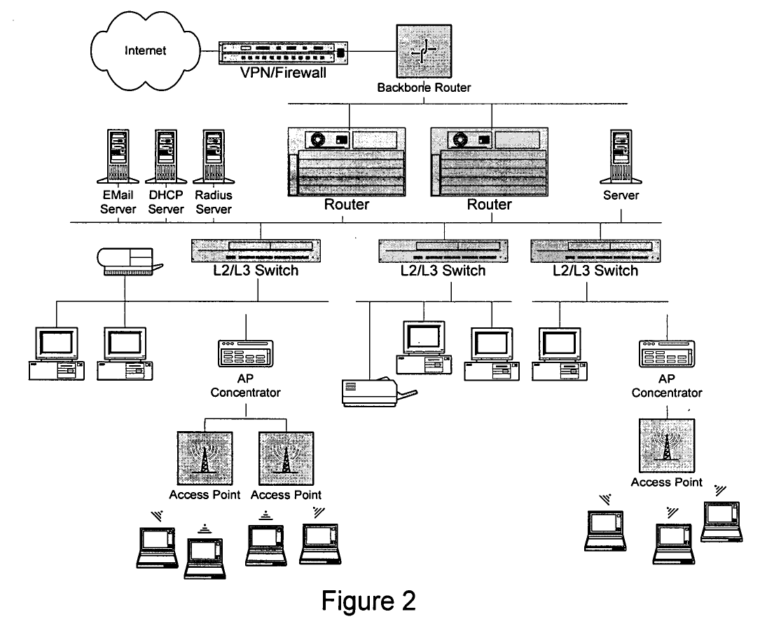

FIG. 3 depicts a Wireless Local Area Network that uses and Intelligent Access Point of the PRIOR ART.

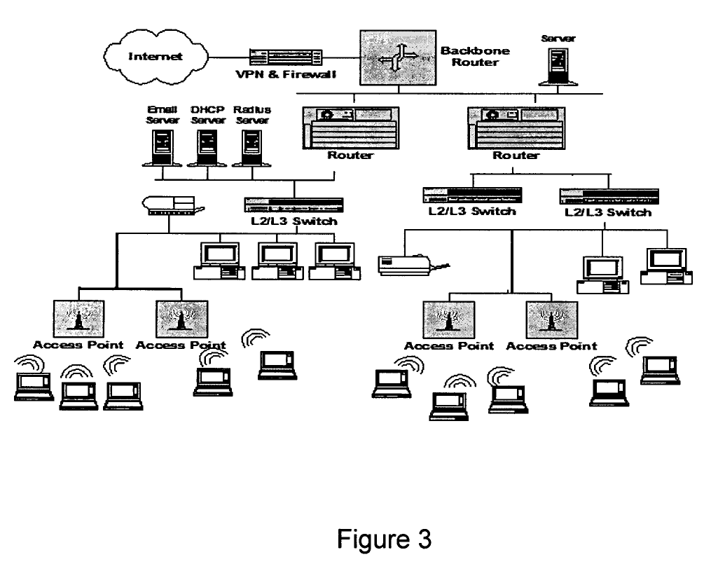

FIG. 4 depicts a Wireless Local Area Network that uses a WLAN Concentrator of the PRIOR ART.

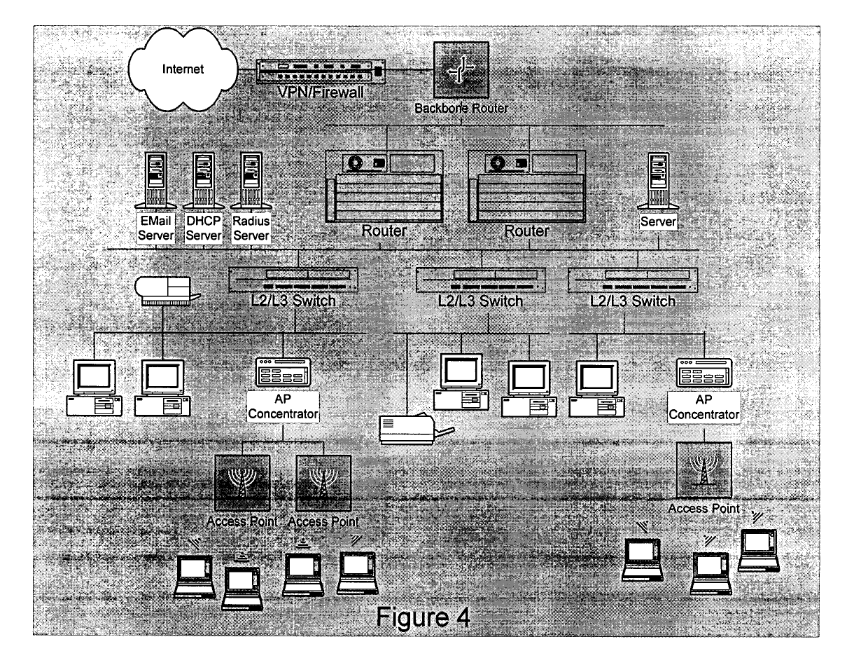

FIG. 5 depicts a Wireless Local Area Network that uses a WLAN switch of the PRIOR ART.

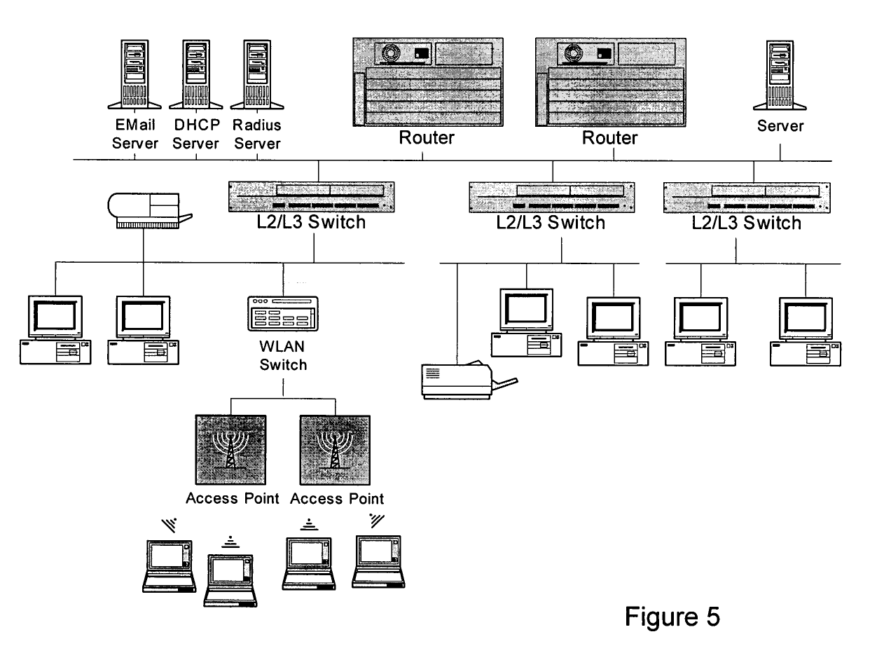

FIG. 6 depicts a Wireless Local Area Network that uses a WLAN appliance of the PRIOR ART.

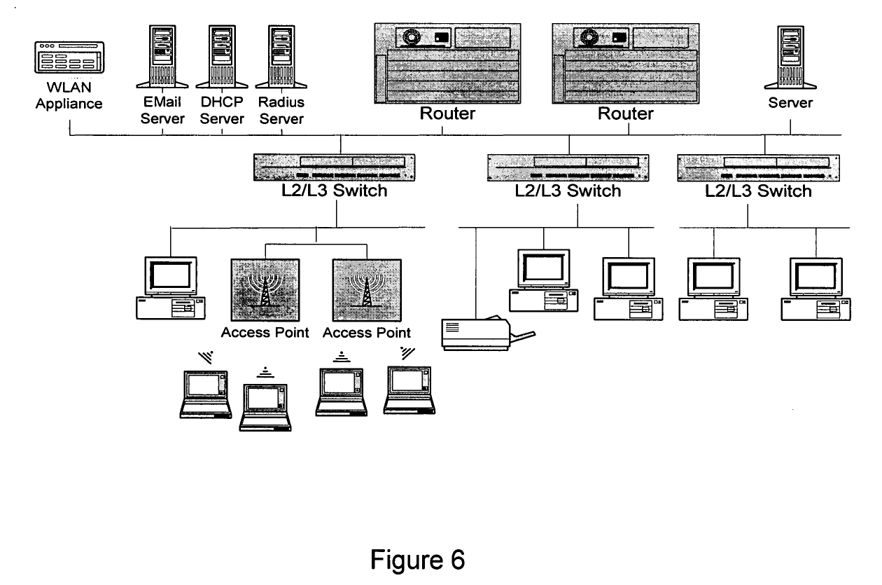

FIG. 7 depicts a Wired/Wireless Local Area Network embodiment of the present invention.

FIG. 8 depicts a 24 Port FE Switch with 4 Gig Uplinks embodiment of the present invention.

FIG. 9 depicts a 48 Port FE with 4 Gig Uplinks embodiment of the present invention.

FIG. 10 depicts an Access Point Controller embodiment of the present invention.

FIG. 11 depicts a Packet Processing Engine embodiment of the present invention.

FIG. 12 depicts a Embedded Processor Engine embodiment of the present invention.

### DETAILED DESCRIPTION

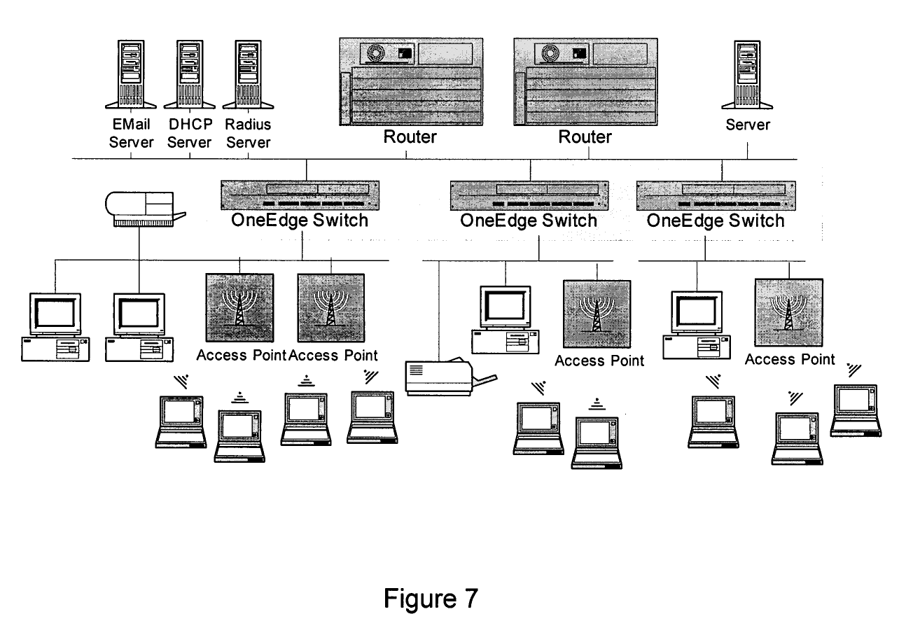

The embodiments of the present invention include a unified network architecture where packets are processed by the same device, Hybrid Device, regardless of whether they have been sourced by wired or wireless clients. A Hybrid Device network is shown in FIG. 7. The ports in this embodiment are agnostic to the nature of the incoming traffic and are able to accept any packet—clear or encrypted. Encrypted traffic is decrypted in hardware and then is subjected to the same packet processing, access control list (ACL) and switching logic as clear traffic. Similarly, clear traffic, after being switched, is encrypted by the hardware and sent to the destination if the end-point is configured to receive encrypted traffic. The consequence of this architecture is that the enterprise network may now be deployed without any consideration for how the wired and wireless clients are geographically situated. A single embodiment device at the edge of this network accepts and processes both wired and wireless traffic. This is a paradigm shift from prior architectures which either isolated the wireless networks within the enterprise networks or tunneled wireless traffic through the enterprise network to a single device that was capable of processing it.

The embodiments provide features for both wireless and wired networks.

Features for wired network may include:
L2 Switching functionality
   Wire speed L2 switching on all ports
   Support for IEEE 802.1D Standard.
      Support for STP, Multiple Spanning Tree (802.1S)
   Support for IEEE 802.1p standards
      8 priority levels can be mapped to any of the configurable CoS queues.
      Support for multicast.
   Support for IEEE 802.1Q standard
      Support for 4K VLANs
      Port based VLANs for untagged and priority tagged packets
      Independent VLAN Learning (IVL).
L3 Switching functionality
   Support for wire speed L3 switching
   Support for forwarding based on ARP Cache and Longest Prefix Match
   Support for IP Multicast Groups
   Support for both (S,G) and (*,G) based lookups
      The same IP Multicast table can be used for L2 Multicast switching
   Support for replications per interface
Supports Flow Control
   Support for jamming for half duplex FE interface
   Support for 802.3x Flow control
   Selective flow control per station based on traffic policing
Packet Aging
Trunking Support
   Support for Trunk Groups
   Load distribution criterion is based on Source MAC address, Destination MAC Address, Source MAC and Destination MAC combination, Source IP Address, Destination IP Address, Source and Destination IP combinations.
Mirroring Support
   Mirroring based on Ingress
   Mirroring based on Egress
   Mirroring based on packet classification
Packet Classification
   L2, L3 and L4 packet classification
   Packet Filtering based on packet classification
   ACL based on classified packets
   QoS ACL based on packet classification
   DiffServ—Behavior Aggregate (BA) and Multi-field (MF) aggregate based on packet classification.
Rate Limiting
   Rate limiting for Broadcast and Multicast.
   Rate limiting packets going to Management CPU over PCI-X.
MIB Support
   Support for MIB-II, Mini-RMON (EtherStats), Etherlike, Ethernet MIB, Bridge MIB, IPSec MIB, L2TP MIB, DiffServ counters
Support for Stacking in the Hybrid-Device
   Two or more Hybrid devices connected to each other by two GMII interfaces that act as a trunked stacking link, so as to support 48 or 96 port configurations. For an external management entity the 48 or 96 port switch constructed using stack link should look like management entity that supports
      L2 and L3 switching across the stack
      VLAN and priority may be preserved across the stack
      QoS queue may be preserved across the stack
      Trunking across the stack
      Mirroring across the stack
      Non-blocking performance on FE port
      Gigabit port uses higher clocking to provide non-blocking
Support for Chassis-based solutions in the Hybrid-Device
   Up to 32 Hybrid devices can be connected using a Gigabit Switch to create a chassis based switching solution.
Access Control
   Based on Class of User, Network and Application
   Based on Location and Time
   User rights based network access
   User rights based application access
Bandwidth Control and Management per User
   Metering
   Policing
      Minimum of 8 kbps granularity up to 1 Mbps.
      Granularity of 1 Mbps above 1 Mbps.
   Shaping Per CoS Queue
   Minimum Guaranteed Bandwidth per Queue
   Maximum Allowed Bandwidth per Queue
QoS/User Level
   Handles 8 levels of 802.1p packet priorities
   Handles DSCP
   QoS ACL
   Scheduling: Strict Priority (SP) and Class-based Weighted Fair Queuing (CBWFQ) Weighted Round Robin (WRR).

Features for wireless networks may include:
All wired features
Encapsulations identified by ethertype, IP protocol, GRE protocol, or UDP ports
   Examples: L2LWAPP, L3LWAPP, GRE, IP only, 802.3 only
Security
   Proven and scalable IPsec VPN based solution
   IPsec Tunnels to be terminated at the edge of trusted networks.
   Authentication (MD5, SHA-1, MD5-HMAC, SHA1-HMAC)
   Encryption (DES, 3DES, AES)
   802.11i (WEP, TKIP-WEP, AES-CCMP) Encryption and Authentication support
   Authenticated IP Address/MAC Address Based Filtering
   Alarms and Events notification to host CPU for logging.
Roaming
   Roaming Within and Between Subnets
   NAT/PAT to support roaming between Subnets
   Mobile IP support
   IP-in-IP support for proprietary protocols
Traffic Management
   Hooks for VoIP over WLAN.
      Packet classification based on type of traffic
      Diffserv support
      Shaping with minimum granularity that to support VoIP traffic
   Queues per user and per session.
   Configurable queues per port
   Ability to move Queues across interfaces to support roaming.

Embodiments provide a unified switching platform for wired and wireless traffic. Ports in the device embodiments may accept and process any type of traffic—wired or wireless, clear or encrypted. A network breach from a wireless network the Access Point/port may be identified easily and isolated. Embodiments may allow for roaming across a Layer 2 or Layer 3 network. Embodiments may full allow application persistence within an L2/L3 network, line rate encrypted IPSec/L2TP/802.11i packet processing capability, and L2 to L4 based access control processing capability. Some embodiments may be configured to prevent the deployment of mis-configured or un-configured access points. Embodiments include very scalable solutions targeted for small to large enterprise networks, may allow centralized access point deployment and management, and also support architectures that use Intelligent, Dumb Access Points or both.

Hybrid-Device Embodiment

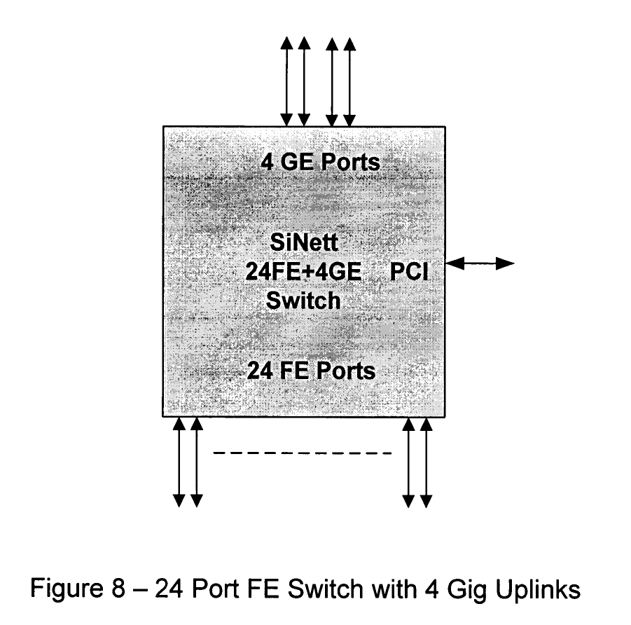

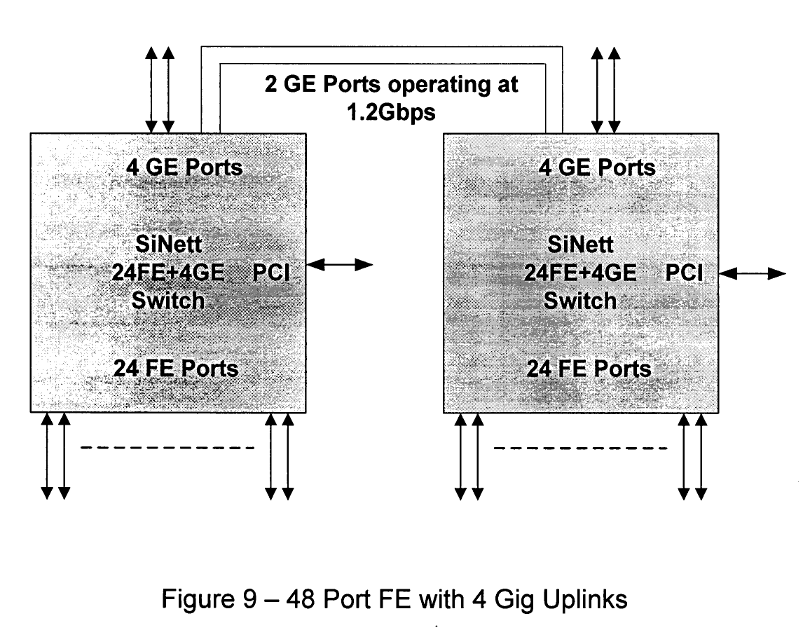

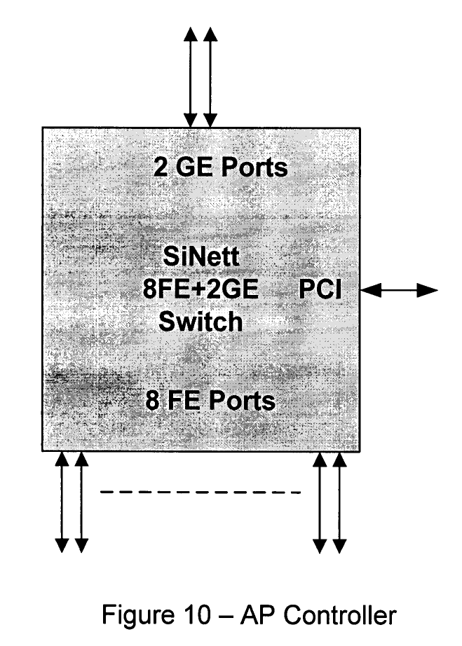

As depicted in FIG. 8, this embodiment is mainly used for Wireless ready Small and Medium Enterprise applications or Access Point Concentrator. There are 24 SMII interfaces for 24 FE ports and 4 GMII interfaces for Gig ports on this device. Various applications using this device are illustrated in FIGS. 9 and 10. Hybrid Device embodiments may be coupled resulting in devices with a larger port count, e.g., the Hybrid Wireless Ready 48 Port FE Device with 4 Gig Uplinks shown in FIG. 9.

Hybrid Features:

Provides unified switching platform for wired and encrypted wireless traffic
Interfaces
   24 SMII interfaces for FE ports+4 GMII interfaces+PCI-X
Advanced Security
   Authentication (MD5, SHA-1, MD5-HMAC, SHA1-HMAC)
   Encryption (DES, 3DES, AES)
   802.11i Encryption and Authentication support
   Authenticated IP Address/MAC Address Based Filtering
   Send Alarms and Events to host CPU for logging.
Roaming
   Roaming Within and Between Subnets
   NAT/PAT to support roaming between Subnets
   Mobile IP support
   IP-in-IP support for proprietary protocols
Support For Revenue Generating Services
   Fine Grain QoS
   Bandwidth Control and Management
   Support MIBs for billing
Security
   Supports proven and scalable IPsec VPN based solution
   Allows IPsec Tunnels to be terminated at the edge of trusted networks.
Access Control
   Based on Class of User, Network and Application
   Based on Location and Time
   User rights based network access
   User rights based application access
Bandwidth Control and Management per User
   Metering
   Policing
      Minimum of 16 kbps granularity up to 1 Mbps.
      Granularity of 1 Mbps above 1 Mbps.
   Shaping Per CoS Queue
   Minimum Guaranteed Bandwidth per Queue
   Maximum Allowed Bandwidth per Queue
QoS/User Level
   Handles 8 levels of 802.1p packet priorities
   Handles DSCP
   QoS ACL
   Scheduling: Strict Priority (SP) and Class-based Weighted Fair Queuing (CBWFQ)
L2 Switching functionality
   Supports IEEE 802.1D Standard.
      Supports STP, Multiple Spanning Tree (802.1S)
   Supports IEEE 802.1p standards
      8 priority levels may be mapped to any of the configurable CoS queues.
      Supports multicast groups.
   Supports IEEE 802.1Q standard
      Supports 4K VLANs
      Port based VLANs for untagged and priority tagged packets
      Independent VLAN Learning (IVL).
Supports Flow Control
   Supports jamming for half duplex FE interface
   Supports 802.3x Flow control
   Selective flow control per station based on traffic policing
L3 Switching functionality
   Supports L3 switching
   Supports forwarding based on ARP Cache and Longest Prefix Match
   Supports for 256 IP Multicast Groups
   Supports both (S,G) and (*,G) based lookups
      The same IP Multicast table may be used for L2 Multicast switching
   Supports a maximum of 8 replications per interface
Packet Aging
Trunking Support
   Supports 32 Trunk Groups
   Maximum of 8 ports in the Trunk Group.
   Load distribution criterion is based on Source MAC address, Destination MAC Address, Source MAC and Destination MAC combination, Source IP Address, Destination IP Address, Source and Destination IP combinations.
Mirroring Support
   Mirroring based on Ingress
   Mirroring based on Egress
   Mirroring based on packet classification
Packet Classification
   L2, L3 and L4 packet classification
   Packet Filtering based on packet classification
   ACL based on classified packets
   QoS ACL based on packet classification
   DiffServ—Behavior Aggregate (BA) and Multi-field (MF) aggregate based on packet classification.
Rate Limiting
   Rate limiting for Broadcast and Multicast.
   Rate limiting packets going to Management CPU over PCI-X.
MIB Support
   Supports MIB-II, Mini-RMON (EtherStats), Etherlike, Ethernet MIB, Bridge MIB, IPSec MIB, L2TP MIB, DiffServ counters
Host Interface
   32-bit PCI-X interface running at 133, 66, 33 MHz.
   4 logical interfaces on PCI-X Bus including Host
   Packet DMA Support
   Scatter Gather Functionality for DMA
   At least 4 channels per logical interface—2 for Rx and 2 for Tx.
   Counter DMA which may be mainly used to gather counters
   Data DMA which may be mainly used by the Host to read from or write to tables and registers on the chip
   Support to deliver Control Messages to Host CPU.
Support for Stacking in the Hybrid-Switch
   Two or more Hybrid chips connected to each other by two GMII interfaces that acts as a trunked stacking link, so as to support 48 or 96 port configurations. For an external management entity the 48 or 96 port switch constructed using stack link should look like management entity that supports
      L2 and L3 switching across the stack
      VLAN and priority may be preserved across the stack
      CoS queue may be preserved across the stack
      Trunking across the stack
      Mirroring across the stack
      Supports non-blocking performance on Gigabit port
      Supports non-blocking performance on Gigabit port
      Gigabit port uses higher clocking to provide non-blocking
Support for Chassis-based solutions in the Hybrid-Switch
   Up to 32 Hybrid devices may be connected using a Gigabit Switch to create a chassis based switching solution.

### Hybrid Architecture Embodiments

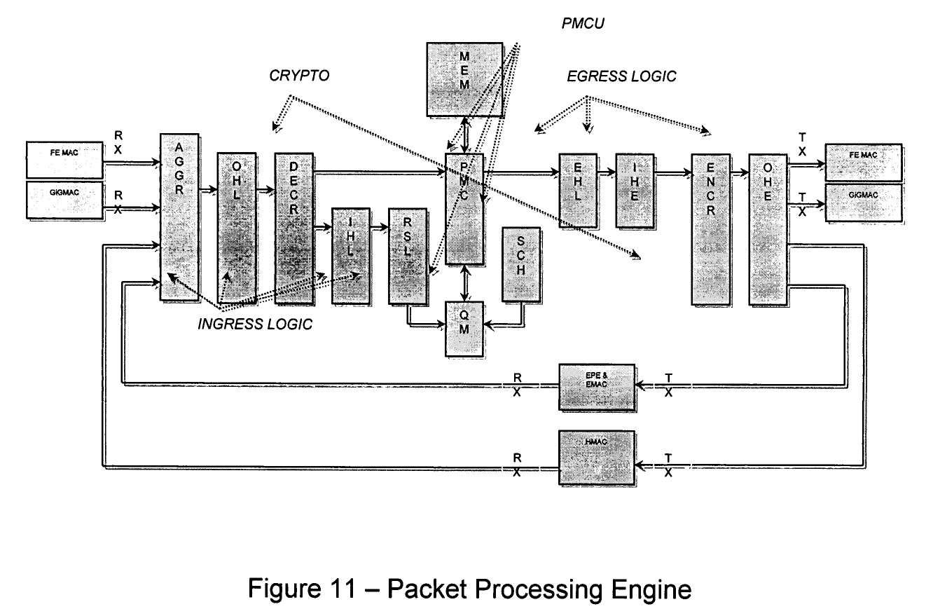

FIG. 11 depicts a Hybrid Architecture embodiment. Solutions to resolve/overcome the weaknesses of WLAN are currently only available in the form of Software or System. The solutions resolve only specific WLAN problems and they don't address all of the existing limitations of wireless networks. The Hybrid Packet Processing Engine delivers an integrated single chip solution to solve Switching/Bridging, Security, Access Control, Bandwidth Management—Quality of Service issues, Roaming—Clean Hand off, Support for Revenue Generating Services—Fine grain QoS, Bandwidth Control, Billing and management. The architecture is such that it not only resolves the problems pertinent to WLAN it unifies L2 and L3 switching of wired and wireless traffic in a same chip. It is also scalable and useful for building a number of useful networking embodiments that fulfill enterprise security and networking needs.

The Hybrid architecture comprises an Ingress logic, Packet memory Control Unit, and Egress Logic.

Ingress Logic comprises MAC RX/Receive side for GE, FE, Embedded Processing Engine (EPE), and Host CPU, an Aggregator, Outer Header Lookup block (OHL), Decryption block, Inner Header Lookup block (IHL) and a Resolution block (RSL).

Egress Logic comprises MAC TX/Transmit side for GE, FE, EPE and Host CPU, Egress Header lookup (EHL), Inner Header Edit (IHE), Encryption Block (ENCR), and Outer Header Edit (OHE).

The Packet Memory Control Unit comprises Packet Memory Controller (PMC), Queue Manager (QM) and Scheduler (SCH).

The FE and GE MAC RX receive packets from the Ethernet link and processes the packet based on Ethernet Receive data link requirements. The RX transfers the data from the MAC clock domain to the core clock domain and interfaces with the AGR to combine the individual traffic stream from each port into and aggregated time division multiplexed stream of slots. The number of slots occupied depends on the bandwidth of the port. The aggregate traffic goes through the Outer Header Lookup (OHL) which performs L2, L3 lookups and also determines the security encryption of the packet. The OHL lookup results are sent to the Resolution (RSL) directly. The OHL security encryption lookup result together with the OHL buffered data are sent through the Decryptor (DECR) to convert from ciphertext packet into plaintext packet. The plaintext data is then sent to the Inner Header Lookup (IHL) for inner L3, NAT, and ACL the IHL lookups. The lookup results are also sent to the RSL. The plaintext packet is then sent to the external packet memory via the Packet Memory Control (PMC). Along with complete plaintext packet is also stored additional information that is for egress processing. Other information such as packet length, number of replications per packet, the ingress port are stored per-port in the Queue Manager (QM). The forwarding scope is determined based on data provided to the RSL and the packet is queued into the QM whose queues are then scheduled by the Scheduler (SCH) to be transmitted to the output ports.

The SCH schedules the packet out of the QM queues and the corresponding data is retrieved from the PMC. The retrieved aggregate traffic may go through the Egress Header Lookup (EHL) to determine the security encryption. After the lookup is done, the result and the buffered data which may be first edited by the Inner Header Edit (IHE) are sent through the Encryptor (ENCR) for packet encryption. Additional packet editing is performed in the Outer Header Edit (OHE) and the aggregate traffic is then sent to the individual TX output which then transfers data from the core clock domain to the MAC clock domain. The MAC handles the Ethernet Transmit data link layer Factors.

The functional description of each of each sub-architecture block is described above.

MAC Receive (Media Access Controller)

This block contains Receive part of the media access controller for FE, GE, Host and the EPE. This block also handles the receive MIB's.

AGR (Aggregator)

This block aggregates traffic from all the receive ports into a single stream of data for pipe-lined packet processing. The output of this block is a time sliced 64-bit data stream plus control information indicating receive port number, sop, eop, packet length, and CRC error status.

Runt packets are dropped by the MAC Receive side. Large packets are truncated and dropped using a CRC check.

OHL (Outer Header lookup)

This block performs the following lookups for Layer 2 switching, Layer 3 switching and Security: MAC Source Address MAC Source Address plus VLAN ID, MAC Destination Address plus VLAN ID, MAC Destination Address, L2 multicast, Outer IP Destination Address, Outer IP Source Address.

The IP Source Address plus SPI lookup is used to determine the decryption process for the packet. The lookup key for the lookups is extracted from the packet. The OHL is passed 64-bits of a packet at a time, so the parsing is incremental. Data proceeds to the DECR block while the lookup results are sent to the DECR as soon as the lookups are done and not until eop. Some lookup results are sent to the RSL directly.

DECR (Decryptor)

The Decryptor supports 4 authentication processes: MD5, SHA-1, HMAC-MD5 and HMAC-SHA-1, and 3 decryption processes: DES, 3DES, and AES. The DECR contains sufficient cores to meet flows from FE, GE, PCI, and EPE.

The decrypted plaintext is stored in the external packet memory by the PMC. In the mean time, the data is sent to the IHL for inner header lookups. The authentication result is sent to RSL together with the IHL lookup results. The decryption and authentication are done in parallel.

IHL (Inner Header Lookup)

This block performs the following lookups: inner IP Destination Address, inner IP Source Address, NAT, NAT'ed IP Destination Address, and ACL. L3 processing comprises a pre-NAT and post-NAT. ARP, Multicast and LPM lookups are done as part of pre-NAT processing and ARP table lookup is performed as part of post-NAT processing. This is to account for changes in destination address.

The RSL may do policing and VLAN lookup (then STP lookup) in parallel, and trunking lookup may be performed after the final portmap is determined. Egress port mirroring is determined after trunking.

NAT

The Hybrid device supports NAPT and also uses it in a novel way to support station mobility or roaming.

ACL

The Access Control Logic is part of Ingress Inner Header Lookup. It serves to limit WLAN user access to domains, services and or applications on the wired side of the enterprise network. This works on top of privileges normally assigned to a user via network user id. Access Control Logic processes a list of rules top down that in total represent the overall corporate access policy for the user. The rules are grouped into what is commonly referred to as an Access Control List. Access Control Lists may be constructed to limit access control from “no access” to “highly selective access”.

Access Control List may be part of the user profile and available from LDAP server or Microsoft Active Directory Database. The Access control statements may be used to apply control based on:
Group, Department, Organization
User
Application
Time of day
Source and Destination address
Flows and micro flows

ACLs are also used for assigning the packet priority, policing and bandwidth management. Such ACL are called QoS ACLs. The QoS ACL is used for packet classification, packet marking and re-marking (802.1p and/or DSCP—DiffServ Code Point), and policing using token bucket process.

PLCR (Policer)

This block only interfaces with the RSL block and its major function is to police the packets classified into up to 4K flows.

RSL (Resolution)

This block takes the lookup results from the OHL, the DECR, and the IHL, to determine if the packet is to be forwarded. The result is sent to the QM to queue the packet. The decisions are made once the end of packet is reached.
1. Select VID between OHL lookup and IHL VID based on route enable.
2. Select priority between OHL and ACL based on acl_update_priority
3. Select Flow ID between OHL FlowID, PriorityTo Flow Table and DSCP To Flow Table based on route_en and PortCfg Table.
4. Construct EGRESS_PORT_BITMAP—
   a. Select between OHL_portmap and IHL_portmap based on route_en
   b. Add mirror port if necessary
   c. Resolve Trunks
   d. Update based on CPU/EPE Flags
5. Update Mirror field, add mirror port to Port Bitmap
6. CPU/EPE Flags —
   a. Gather flags from RSL, IHL, OHL, and DECR
   b. Mask with Flag registers to determine destination EPE/HOST
   c. Replace Egress PortBitmap
   d. If Bitmap ==0, Don't Queue Packet
   e. Select 16 bit flags (and 4 bit code) to send to PMC

PMCU (Packet Memory Controller)

The main functionality of PMCU is to manage packet memory, packet pointers, queue management and scheduling of packets from and going to Hybrid 33 ports. The packet memory comprises external SDRAM implemented using DDR with 16 Gbps of sustained bandwidth. The external memory may be up to 128 M Bytes. The SDRAM shared memory is partitioned into 32K buffers with each buffer 4 KB.

The PMC appends CRC to packets stored in memory and performs CRC check on packets leaving the memory to check for memory corruption due to Alpha particles.

QM (Queue Manager)

Queue Manager manages all the Physical Queues and List of Free Queues. Once the packet is fully assembled in the packet memory, the Queue Manager inserts the packet pointer at the end of the physical queue of the interface on which it is destined to go out and updates the tail pointer to point to this last packet pointer.

The scheduler schedules the next packet by providing the queue ID along with the schedule request to the Queue Manager. The De-Queue engine reads the head pointer to determine the head of the queue and the queue length for the queue. The action is then based on the Multicast bit in the queue pointer. If the bit is not set it is considered as a unicast packet else it is a multicast packet.

SCH (Scheduler)

The QM sends queuing information to the SCH so that it knows when a queue is available for scheduling. A packet is scheduled only if the shaper may satisfy the number of tokens for the packet.

The SCH supports DRR (Deficit Round Robin).

SHPR (Shaper)

The Shaper is part of the SCH and its major function is to regulate the flow of traffic out of the 4K queues. The packet length in combination with number of tokens in the shaper bucket for a queue determine if a packet is scheduled by SCH for dequeuing by the QM.

EHL (Egress Header Lookup)

This block performs two major lookups: outbound ACL and outbound SA. The outbound ACL is used to determine whether the packet needs to be dropped. The outbound Security Association is used to determine encryption for the packet. The EHL is passed with 64-bit of the packet at a time, so the key extraction is done incrementally.

After the ACL and the Security Association lookups are finished the results are sent to the ENCR.

IHE (Inner Header Editor)

This block processes the aggregate traffic in a pipeline with various processing stages. Before the ACL and the SA lookups are finished, the data may not be sent to the ENCR and may be saved into a temporary buffer.

This block is implemented with an n-stage pipeline with each stage performing one editing task such as VLAN ID insert/strip, MAC Destination Address and MAC Source Address replacement/TTL and checksum adjustment for routed packets, and so on.

The packet dropped by the ACL may not be sent to the ENCR.

ENCR (Encryptor)

The Encryptor supports 4 authentication processes: MD5, SHA-1, HMAC-MD5, and HMAC-SHA-1. It also supports 3 encryption processes: DES, 3DES, and AES.

The plaintext packet is encrypted first and then authenticated. The ENCR contains separate cores for FE, GE, PCI, and EPE.

After the encryption is done, the block data is sent to the OHE (outer header editor). The data from the OHE may be sent to the DSTR (distributor) which may then distribute the data to the appropriate TX.

OHE (Outer Header Editor)

This block processes the aggregate traffic in a pipeline with various processing stages.

This block is implemented with an n-stage pipeline with each stage performing one editing task such as ESP header insert for IPsec packets, for example.

TX (Transmit)

The aggregate traffic is distributed to all the appropriate TX ports using port information. This block also handles the transmit MIB's.

HIU (Host Interface Unit)

The HIU contains a PCI core, a DMA engine, Peripheral Address Bus, a host command interpreter and a register and table access logic. Only one register is used to trigger the DMA operation.

A mode bit may be set by using the PCI configuration cycles to let the PCI access Summit registers and tables directly without having to go through the DMA engine.

EPE (Embedded Processor Engine)

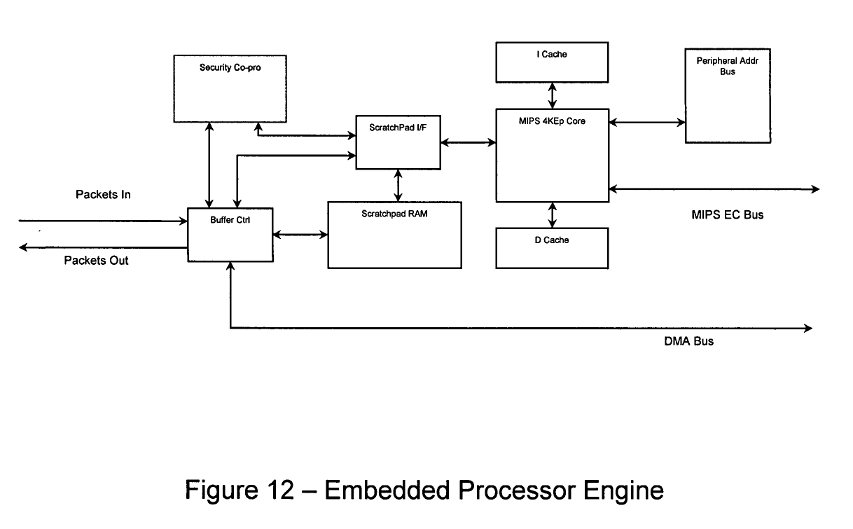

The Embedded Processor Engine is depicted in FIG. 12. The EPE has a processor core (MIPS, SPARC, or other processor core as is known in the art), a system controller, scp (security coprocessor), a 8K data cache, a 16K instruction cache, and a 16K SPRAM connected to the DSPRAM interface.

The SCP is used whenever hardware support is need for SSL ingress and egress processing.

The previous description of the embodiments is provided to enable any person skilled in the art to practice embodiments of the invention. The various modifications to these embodiments may be readily apparent to those skilled in the art, and the generic principles defined herein may be applied to other embodiments without the use of inventive faculty. Thus, the present invention is not intended to be limited to the embodiments shown herein, but is to be accorded the widest scope consistent with the principles and novel features disclosed herein.

1. A device capable of handling both wired and wireless data traffic comprising:
a first port configured to receive a packet;
an ingress block, configured to receive the packet from the first port, to determine whether the packet has to undergo decryption, and to determine a final destination of the packet;
a security block configured to perform decryption of the packet from the ingress path, when the packet has to undergo decryption;
a packet memory configured to store the packet from the ingress path;
an egress path, configured to receive the packet from the packet memory and output the packet to the first port.

2. The device of claim 1, further comprising:
a second port;
wherein the egress path is further configured to output the packet to the second port.

3. The device of claim 2, wherein the second port is configured to handle only wireless traffic.

4. The device of claim 2, wherein the second port is configured to handle only only wired traffic.

5. The device of claim 2, wherein the second port is configured to handle both wired and wireless traffic.

6. The device of claim 2, where the ingress path is further configured to decapsulate a wireless packet based on ethertype, IP protocol, UDP ports, GRE protocol, or other Layer 2, Layer 3 or Layer 4 packet fields.

7. The device of claim 2, where the ingress path is further configured to not encapsulate a wireless packet based the wireless packet's MAC Addresses or IP Addresses.

8. The device of claim 2, wherein the security block is configured to only authenticate the packet.

9. The device of claim 2, wherein the security block is configured to authenticate or decrypt the packet.

10. The device of claim 2, further comprising:
a packet memory scheduler configured to schedule the packet from the packet memory to the egress path.

11. The device of claim 2, wherein the egress path is further configured to modify the packet depending upon a packet destination specified by the packet.

12. The device of claim 10, where the egress path is further configured to encapsulate an outgoing wireless packet based on ethertype, IP protocol, UDP ports, GRE protocol, or other Layer 2, Layer 3 or Layer 4 packet fields.

13. The device of claim 10, where the egress path is further configured to not encapsulate an outgoing wireless packet, but to modify the outgoing wireless packet's MAC Address or IP Address to addresses specific to wireless clients.

14. The device of claim 10, wherein the egress path is further configured to determine whether the packet has to undergo encryption or authentication.

15. The device of claim 14, wherein the egress path is further configured to determine whether the packet has to undergo only encryption.

16. The device of claim 14, wherein the egress path is further configured to determine whether the packet has to undergo only authentication.

17. The device of claim 14, wherein the security block is further configured to encrypt or authenticate the packet for the egress path.

18. The device of claim 17, wherein the security block supports IEEE 802.11i, IPSec, L2TP with IPSec, PPTP, or SSL Encryption algorithms.

19. The device of claim 18, wherein the egress path or the ingress path further comprises:
access control logic configured to modify the packet based an access control list.

20. A method of agnostically handling wired and wireless data traffic comprising:
receiving a packet from a wired and/or wireless devices;
authenticating the received packet, rejecting the packet if the packet is not authenticated;
unencrypting the received packet, if the packet is encrypted;
determining a final destination of the packet;
storing the packet;
outputting the packet towards the final destination.

21. The device of claim 2, wherein the first port is configured to handle only wireless traffic.

22. The device of claim 2, wherein the first port is configured to handle only only wired traffic.

23. The device of claim 2, wherein the first port is configured to handle both wired and wireless traffic.
